(19) United States
(12) Patent Application Publication
(10) Pub. No.: US 2026/0095642 A1
(43) Pub. Date: Apr. 2, 2026

(54) INFORMATION PROCESSING APPARATUS, INFORMATION PROCESSING METHOD, AND INFORMATION PROCESSING PROGRAM

(71) Applicant: SONY GROUP CORPORATION, TOKYO (JP)

(72) Inventor: HIROSHI IKEDA, TOKYO (JP)

(21) Appl. No.: 19/111,981

(22) PCT Filed: Sep. 12, 2023
(86) PCT No.: PCT/JP2023/033130

§ 371 Date: Mar. 14, 2025

(30) Foreign Application Priority Data
Sep. 22, 2022 (JP) 2022-151845

(51) Int. Cl. H04N 23/611; G06T 7/246; G06T 7/73; G06V 40/10; G06V 40/20; H04N 23/69

(52) U.S. Cl. CPC H04N 23/611; G06T 7/246; G06T 7/73; G06V 40/10; G06V 40/20; H04N 23/69; G06T 2207/30196

(57) ABSTRACT

An information processing apparatus according to an aspect of the present disclosure includes: a determination unit that determines necessity of stopping tracking shooting currently being executed on the basis of whether or not a state of a subject on which the tracking shooting is being executed satisfies a predetermined condition; and a control unit that stops the tracking shooting of the subject according to a determination result of the necessity.

### Field

The present disclosure relates to an information processing apparatus, an information processing method, and an information processing program.

### BACKGROUND

Conventionally, techniques for tracking objects captured in captured images have been proposed. For example, Patent Literature 1 proposes a method for reliably tracking an original tracking target even in a case where a plurality of persons intersects in a screen.

### CITATION LIST

### Patent Literature

Patent Literature 1: JP 2010-243730 A

### SUMMARY

### Technical Problem

For example, in the conventional technique described above, in a case where there is a plurality of persons in one frame image captured this time during tracking, processing of detecting a correct tracking target from among persons in one frame image captured this time by collating the face and face orientation of each person with the face and face orientation of each person in one frame image captured last time is executed continuously in accordance with capturing of the frame images.

According to such a conventional technique described above, for example, in a case where another person crosses in front of the person who is tracking, the problem of failing tracking or chasing a person who is not a tracking target can be solved. On the other hand, in the above-described conventional technique, there still remains a problem that, in a case where a person crossing has a similar face, the person is erroneously tracked.

In this way, if a wrong object different from the original tracking target continues to be tracked, a video that is not valuable to the user is obtained. Therefore, in a case where it is suspected that the subject on which the tracking shooting is being executed is different from the original tracking target, an automatic recovery function capable of re-recognizing the original tracking target is required.

Therefore, the present disclosure proposes an information processing apparatus, an information processing method, and an information processing program capable of effectively reducing opportunities for obtaining a valueless video due to erroneous tracking shooting.

### Solution to Problem

In order to solve the above problems, one aspect of An information processing apparatus comprising: a determination unit that determines necessity of stopping tracking shooting currently being executed on a basis of whether or not a state of a subject on which the tracking shooting is being executed satisfies a predetermined condition; and a control unit that stops the tracking shooting of the subject according to a determination result of the necessity.

### BRIEF DESCRIPTION OF DRAWINGS

FIG. 1 is a diagram illustrating a configuration of a system according to an embodiment.

FIG. 2 is a diagram illustrating an outline of tracking determination processing according to the embodiment.

FIG. 3 is a diagram illustrating an example of a schematic configuration of an information processing apparatus according to the embodiment.

FIG. 4 is a flowchart illustrating a flow of entire information processing executed by an imaging apparatus.

FIG. 5 is a flowchart illustrating a flow of tracking determination processing executed by the imaging apparatus.

FIG. 6 is a diagram illustrating an example (1) of a schematic configuration of an information processing apparatus in a modification according to the embodiment.

FIG. 7 is a diagram illustrating an example (2) of a schematic configuration of an information processing apparatus in a modification according to the embodiment.

FIG. 8 is a diagram illustrating an example (3) of a schematic configuration of an information processing apparatus in a modification according to the embodiment.

FIG. 9 is a block diagram illustrating a hardware configuration example of a computer corresponding to the information processing apparatus according to the embodiment.

### DESCRIPTION OF EMBODIMENTS

Hereinafter, an embodiment of the present disclosure will be described in detail with reference to the drawings. Note that the information processing apparatus, the information processing method, and the information processing program according to the present disclosure are not limited by the embodiment. In addition, in the following embodiment, the same parts are denoted by the same reference signs, and redundant description will be omitted.

### Embodiment

### 1. System Configuration

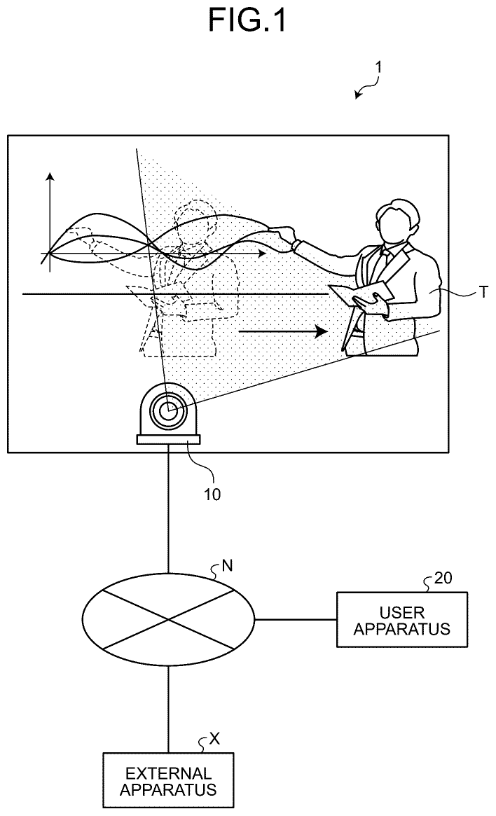

First, a configuration of a system according to the embodiment will be described with reference to FIG. 1. FIG. 1 is a diagram illustrating a configuration of a system according to the embodiment. FIG. 1 illustrates a system 1 as an example of a system according to the embodiment.

As illustrated in FIG. 1, the system 1 may include an imaging apparatus 10, a user apparatus 20, and an external apparatus X. Furthermore, the imaging apparatus 10, the user apparatus 20, and the external apparatus X may be communicably connected in a wired or wireless manner via a network N.

The imaging apparatus 10 may be a camera in which a function (determination processing function DV) for implementing the tracking determination processing according to the embodiment can be equipped. The imaging apparatus 10 equipped with the determination processing function DV can be understood as an information processing apparatus according to the embodiment of the present disclosure.

The imaging apparatus 10 may be any camera as long as it is a camera capable of tracking shooting, for example. As an example, the imaging apparatus 10 may be a pan-tilt-zoom (PTZ) camera.

The external apparatus X is an apparatus communicably connected to the imaging apparatus 10. Here, depending on the type and specification of the imaging apparatus 10, it may be impossible to equip the determination processing function DV. In this case, by equipping the determination processing function DV in the external apparatus X, it is possible to adopt a configuration in which the external apparatus X is caused to perform tracking determination processing instead of the imaging apparatus 10. Examples of the external apparatus X in which the determination processing function DV can be equipped include a notebook personal computer (PC), a desktop PC, and a cloud-side Server apparatus. As described above, the external apparatus X equipped with the determination processing function DV can be understood as an information processing apparatus according to the embodiment of the present disclosure.

Note that the system 1 may include a plurality of imaging apparatuses 10 capable of communicating with each other, and multi-camera cooperation for implementing tracking determination processing in cooperation among the plurality of imaging apparatuses 10 can be adopted.

In the multi-camera cooperation, it is possible to adopt a configuration in which the determination processing function DV is equipped in a main imaging apparatus 10 that is mainly used for tracking shooting, and information processing supporting the main imaging apparatus 10 is performed on another imaging apparatus 10 (sub-imaging apparatus 10). In such an example, the main imaging apparatus 10 can be understood as an information processing apparatus according to the embodiment of the present disclosure.

Furthermore, in the multi-camera cooperation, it is also possible to adopt a configuration in which the determination processing function DV is distributed and equipped between the main imaging apparatus 10 mainly performing tracking shooting and the sub-imaging apparatus 10 having a role of supporting the main imaging apparatus 10. In such an example, a system including the main imaging apparatus 10 and the sub-imaging apparatus 10 can be understood as an information processing apparatus according to the embodiment of the present disclosure.

The user apparatus 20 is an apparatus capable of controlling the information processing apparatus according to the embodiment of the present disclosure, and is a terminal apparatus used by a user who desires a video obtained by tracking shooting. For example, the user apparatus 20 may be a smartphone, a tablet terminal, a notebook PC, a desktop PC, a mobile phone, a PDA, or the like.

FIG. 1 also illustrates an example of a preferred case to which the tracking determination processing according to the embodiment can be applied. According to the example of FIG. 1, an example is illustrated in which the imaging apparatus 10 in which the determination processing function DV is equipped follows the shooting in accordance with the movement of the teacher T in front of the podium. In such an example, the imaging apparatus 10 determines the necessity of stopping tracking shooting with the teacher T as a tracking target on the basis of the state of the subject on which the tracking shooting is being executed, that is, the teacher T.

That is, the imaging apparatus 10 determines whether to stop the tracking shooting or continue the tracking shooting on the basis of the state of the teacher T as the tracking target. Whether to stop or continue the tracking shooting is determined on the basis of whether or not the state of the teacher T as the main subject satisfies the tracking stop condition.

Such tracking determination processing is not limited to the example of FIG. 1, and can be applied to scenes of various events EV. Hereinafter, an example of a use case will be described.

For example, the information processing apparatus according to the embodiment of the present disclosure can be applied at a conference (an example of an event EV). In such an example, the information processing apparatus can perform tracking determination processing when capturing a conference video in which a specific subject (for example, a moderator of a conference) is tracked. When the information processing apparatus is the imaging apparatus 10, the imaging apparatus 10 may be installed in a conference room such as a workplace, for

Furthermore, the information processing apparatus is applicable to a seminar (an example of an event EV). In such an example, the information processing apparatus can perform tracking determination processing when capturing a seminar video in which a specific subject (for example, a lecturer) is tracked. When the information processing apparatus is the imaging apparatus 10, the imaging apparatus 10 may be installed, for example, in a large auditorium or the like used as a seminar venue.

Furthermore, the information processing apparatus can be applied in a competition (an example of an event EV). In such an example, the information processing apparatus can perform tracking determination processing when capturing a live video in which a specific subject (for example, a player) is tracked. When the information processing apparatus is the imaging apparatus 10, the imaging apparatus 10 may be installed in a competition venue, for example.

Furthermore, the information processing apparatus can also be used at a TV program production site (an example of an event EV). For example, the information processing apparatus can perform tracking determination processing when capturing a television video in which a specific subject (for example, the performer) is tracked. When the information processing apparatus is the imaging apparatus 10, the imaging apparatus 10 may be installed at a program shooting site (for example, a shooting studio), for example.

Furthermore, as an application case, the information processing apparatus may be used in a movie theater. For example, the information processing apparatus can perform tracking determination processing when capturing a movie clip video in which a specific subject displayed on the screen is tracked. When the information processing apparatus is the imaging apparatus 10, the imaging apparatus 10 may be installed in a movie theater, for example.

Furthermore, in addition to the above examples, the information processing apparatus is also applicable to tracking and shooting a specific performer (for example, a singer, a musician, a back dancer, or the like) in a live event. When the information processing apparatus is the imaging apparatus 10, the imaging apparatus 10 may be installed at a live venue (for example, a concert hall, a theater, or the like), for example.

In the following embodiment, an example in which the tracking determination processing according to the embodiment is performed by one imaging apparatus 10 equipped with the determination processing function DV is illustrated, and another configuration example of the information processing apparatus according to the embodiment will be described as a modification. In addition, it is assumed that imaging is rephrased as shooting.

### 2. Overall Image of Tracking Determination Processing

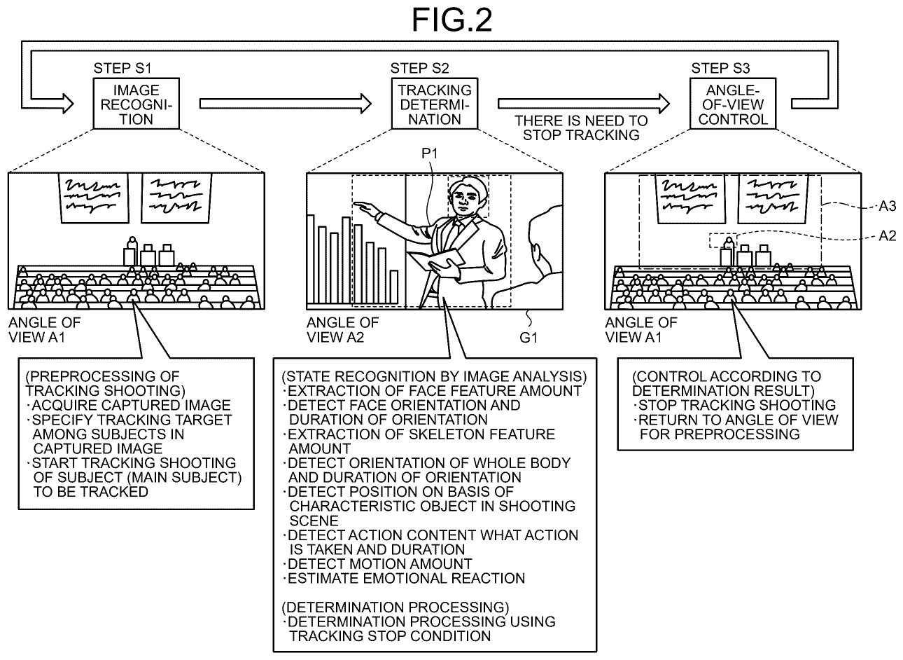

Next, an overall image of the tracking determination processing according to the embodiment will be described with reference to FIG. 2. FIG. 2 is a diagram illustrating an outline of tracking determination processing according to the embodiment. FIG. 2 illustrates a scene in which a class is held in a university as an event EV. In such a case, the imaging apparatus 10 follows the movement (for example, a movement of moving left and right on the podium) of a teacher giving a lecture in a large auditorium, for example. As illustrated in FIG. 2, the operation of the imaging apparatus 10 is roughly divided into image recognition (step S1), tracking determination (step S2), and angle-of-view control (step S3), and the processing may be repeated in this order.

Here, the tracking determination processing according to the embodiment is performed during tracking shooting. Therefore, as preprocessing related to the tracking determination processing, first, the image recognition processing of step S1 may be performed.

The image recognition processing performed as the preprocessing may be performed for the purpose of specifying the tracking target. Therefore, the imaging apparatus 10 controls the angle of view of the own apparatus to be an angle of view A1 suitable for specifying the tracking target, and performs the image recognition processing in a state where the angle of view A1 is captured. That is, the imaging apparatus 10 performs shooting in the normal shooting mode in which objective video is acquired. The angle of view A1 may be an angle of view capable of capturing an overhead view image (an image with enhanced objectivity not focusing on a specific subject) overlooking the entire state of the event EV (class in university).

In the preprocessing of tracking shooting, the imaging apparatus 10 captures a captured image of one frame at a specific timing via a lens. For example, the imaging apparatus 10 acquires the captured image of one frame corresponding to the angle of view A1 at a timing when the tracking shooting mode is selected by the user (for example, an operator of the imaging apparatus 10).

Then, the imaging apparatus 10 specifies a subject to be tracked among the subjects in the captured image by image recognition processing on the captured image. For example, in a case where an image of a person to be tracked is registered in advance, the imaging apparatus 10 may specify the subject to be tracked by matching the registered image with an image of each subject included in the acquired captured image. For example, the imaging apparatus 10 may specify the subject to be tracked by matching the feature amount (for example, a face feature amount, a skeleton feature amount, a wearing object feature amount, and the like) extracted from the registered image with the feature amount (for example, a face feature amount, a skeleton feature amount, a wearing object feature amount, and the like) extracted from each subject image included in the captured image.

Furthermore, the user can operate the user apparatus 20 to check the captured image by the imaging apparatus 10 in real time. Therefore, the user can designate the tracking target using a specific graphical user interface (GUI) displayed on the user apparatus 20. For example, the user can designate the tracking target by a user operation such as surrounding a specific target included in the captured image with a rectangle. Therefore, in a case of receiving the designation of the tracking target from the user apparatus 20, the imaging apparatus 10 may recognize the target designated in the captured image as the tracking target.

Next, in a case where the tracking target can be specified, the imaging apparatus 10 performs control for starting tracking shooting of the specified subject (main subject for the user) as the tracking target. For example, the imaging apparatus 10 may switch from the normal shooting mode to the tracking shooting mode and start tracking shooting at a time point when the tracking target can be specified.

Furthermore, the imaging apparatus 10 may switch to the tracking shooting mode and start tracking shooting at a time point when a main subject, which is a subject specified as a tracking target, satisfies a specific condition. Examples of the specific condition include a condition related to a position/region of the subject to be tracked in the captured image, movement of the subject to be tracked, a state of the subject to be tracked, and a relationship between the shooting scene and the subject to be tracked. For example, in a case where the imaging apparatus 10 can recognize that the main subject has entered a specific imaging range by image recognition for a captured image captured as needed via the lens, the imaging apparatus 10 may start tracking shooting.

Furthermore, the imaging apparatus 10 may start tracking shooting in a case where it is recognized that the main subject satisfies a specific condition by image recognition for a captured image captured as needed via the lens. Here, the specific condition is preferably a condition suitable for the relationship between the shooting scene in the event EV and the tracking target.

In the example of FIG. 2, the shooting scene in the event EV is a scene that a teacher teaches a student in a university class. In such a scene, conditions that the main subject starts speaking, the main subject smiles, and the main subject possesses a certain article (for example, penlight) can be cited as the conditions for switching to the tracking shooting mode. Such a condition may be dynamically determined by the imaging apparatus 10 understanding the content of the event EV by applying the captured image to the existing machine learning technology, or may be set in advance by the user for the imaging apparatus 10.

Furthermore, the switching to the tracking shooting mode by the imaging apparatus 10 may include processing of switching from the current angle of view A1 to the angle of view A2 focused on the main subject.

When the tracking shooting is started in this manner, the imaging apparatus 10 proceeds to the tracking determination processing in step S2. In the example of FIG. 2, an example is illustrated in which the imaging apparatus 10 specifies the person P1 as the main subject, and thus, performs tracking shooting in a state of focusing on the person P1 while detecting the whole body and the face portion of the person P1 from the captured image G1 captured as needed. As illustrated in FIG. 2, the imaging apparatus 10 may perform tracking shooting while detecting the person P1 by cutting out the whole body or the face portion of the person P1 by segmentation or the like. Hereinafter, the person P1 may be referred to as a main subject P1.

In the tracking determination processing, the imaging apparatus 10 performs image recognition for recognizing the state of the main subject P1 by analyzing the captured image G1 obtained by tracking and shooting the main subject P1. Then, the imaging apparatus 10 performs tracking determination processing of determining the necessity of stopping tracking shooting on the basis of whether or not the state obtained as the recognition result satisfies the tracking stop condition.

The imaging apparatus 10 can recognize the state of the main subject P1 by analyzing a partial image segmented (extracted in a rectangular shape) with respect to the captured image G1.

For example, the imaging apparatus 10 may acquire feature points indicating a face pattern from the partial image and quantify the acquired feature points to extract a face feature amount that is a feature amount corresponding to the feature points.

Furthermore, the imaging apparatus 10 may detect the orientation of the face of the main subject P1 and detect the duration of the detected orientation on the basis of the positional relationship of the face parts (eyes, ears, nose, mouth, or the like) included in the partial image. For example, the imaging apparatus 10 can detect the duration in which the state of the orientation of the face detected this time continues on the basis of the time-series data of the captured image G1.

Furthermore, the imaging apparatus 10 may acquire feature points indicating a whole-body pattern from the partial image, and quantify the acquired feature points to extract a whole-body feature amount that is a feature amount corresponding to the feature points.

Furthermore, the imaging apparatus 10 may detect the orientation of the body of the main subject P1 and detect the duration of the detected orientation on the basis of the positional relationship of the body part (neck, waist, shoulder, and the like) included in the partial image. For example, the imaging apparatus 10 can detect the duration in which the state of the orientation of the entire body detected this time continues on the basis of the time-series data of the captured image G1. Note that, in a case where the imaging apparatus 10 detects the orientation of the face as described above, the orientation of the face indicated by the detection result may be regarded as the orientation of the entire body.

Furthermore, the imaging apparatus 10 may detect the position of the main subject P1 on the basis of a characteristic object in the shooting scene in the event EV. According to the example of FIG. 2, the characteristic object in the shooting scene in the event EV may be a podium, a teacher's desk, a whiteboard, or the like. Taking the teacher's desk as an example, the imaging apparatus 10 may detect the position of the main subject P1 with respect to a predetermined range defined to include the teacher's desk.

Furthermore, the imaging apparatus 10 may detect action content indicating what action the main subject P1 is taking and the duration of the action. For example, the imaging apparatus 10 can detect the action content and the duration on the basis of the time-series data of the captured image G1.

Furthermore, the imaging apparatus 10 may detect the motion amount of the main subject P1. For example, the imaging apparatus 10 can detect the motion amount of the main subject P1 on the basis of the time-series data of the captured image G1. Note that, in the captured image G1 illustrated in FIG. 2, other persons are included in addition to the main subject P1. As described above, in a case where another person not targeted for tracking shooting is included, the imaging apparatus 10 may also detect the motion amount of the other person.

Furthermore, the imaging apparatus 10 may estimate the emotional reaction of the main subject P1. For example, the imaging apparatus 10 can detect a change (for example, change from no facial expression to smile) in the facial expression of the main subject P1 on the basis of the facial expression obtained as an analysis result for the captured image G1, and in a case where the change can be detected, can estimate the emotional reaction (for example, a feeling of praising a student) corresponding to the facial expression from the facial expression after the change.

When recognizing the various states of the main subject P1 as described above, the imaging apparatus 10 determines the necessity of stopping tracking shooting with the main subject P1 as a tracking target on the basis of whether or not the state of the main subject P1 satisfies the tracking stop condition. Specifically, in a case where the state of the main subject P1 satisfies the tracking stop condition, the imaging apparatus determines that tracking shooting with the main subject P1 as a tracking target needs to be stopped, and in a case where the state of the main subject P1 does not satisfy the tracking stop condition, the imaging apparatus 10 determines that tracking shooting does not need to be stopped (tracking shooting may be continued). A specific example of the tracking determination processing using the tracking stop condition will be described later.

Note that the case where the state of the main subject P1 satisfies the tracking stop condition means occurrence of a situation in which it is suspicious that tracking shooting is performed on a wrong subject different from the original tracking target (correct tracking target) desired by the user. For such a reason, the tracking determination processing using the tracking stop condition corresponds to a process of determining whether or not the current subject as a tracking target is a correct tracking target on the assumption of a case where a wrong person is tracked from the partway through after starting the tracking shooting.

In a case where the imaging apparatus 10 determines that tracking shooting needs to be stopped, the processing proceeds to the angle-of-view control processing in step S3. In the angle-of-view control processing, the angle of view is controlled to an angle of view according to a determination result that there is a need to stop tracking shooting. In the angle-of-view control processing, the imaging apparatus 10 first stops tracking shooting with the main subject P1 as a tracking target. Then, the imaging apparatus 10 changes the angle of view A2 focused on the main subject P1 for tracking shooting to the angle of view A1 in the preprocessing stage not focused on the main subject P1, and switches to objective video shooting at the angle of view A1.

Here, in a case where the main subject P1 is not the original tracking target, the video obtained by tracking the main subject P1 is a worthless video in which a person (for example, a particular student) not suitable for the shooting scene this time is continuously tracked.

However, in a case where it is suspected that the main subject P1 is not the original tracking target by the tracking determination processing using the tracking stop condition, the imaging apparatus 10 switches to the normal shooting mode in which objective video is acquired, and thus, it is possible to secure the value of the video to some extent. Specifically, in the overhead view image captured at the angle of view A1, although a specific subject is not tracked, the overall image of the event EV is captured, so that the viewer can sufficiently grasp the content of the event EV and it can be said that value is secured.

Furthermore, according to the imaging apparatus 10 according to the embodiment, in a case where it is suspected that the main subject P1 is not an original tracking target, the angle of view is returned to the wider range of the angle of view A1 in which the main subject P1 is not focused. Therefore, it is possible to provide the user with an opportunity to search again the tracking target (recovery opportunity). Note that, in FIG. 2, in a case where it is determined in the tracking stop determination that tracking shooting needs to be stopped, the angle of view is changed to the angle of view A1 at which an overhead view image of the entire state of the event EV can be shot, but the present invention is not limited thereto. That is, the imaging apparatus 10 is only required to change the angle of view to a wider angle of view than the angle of view A2 focused on the tracking target (it is sufficient to control an imaging unit 11 to zoom out). More specifically, in a case where the imaging apparatus 10 determines that tracking shooting needs to be stopped in the tracking stop determination, the angle of view may be changed to an angle of view A3 (the angle of view A3 is wider than the angle of view A2) including a predetermined object (for example, a blackboard, a display, a podium, and the like).

### 3. Configuration Example of Information Processing Apparatus

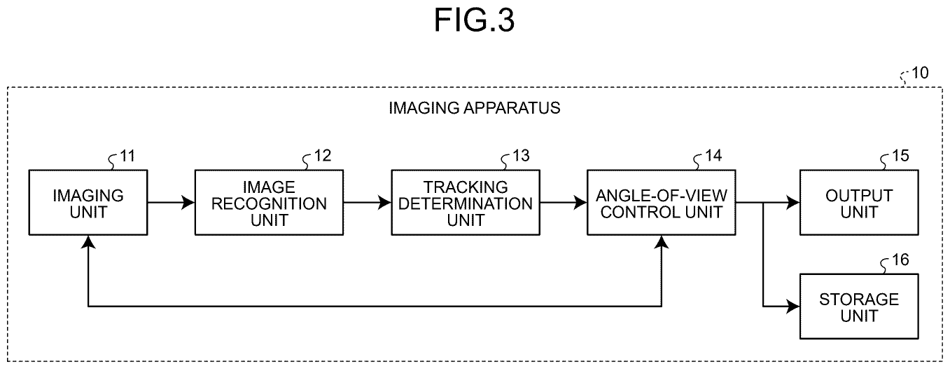

A configuration example of the information processing apparatus according to the present embodiment will be described with reference to FIG. 3. FIG. 3 is a diagram illustrating an example of a schematic configuration of the information processing apparatus according to the embodiment. FIG. 3 illustrates a schematic configuration in a case where the imaging apparatus 10 is implemented as the information processing apparatus according to the embodiment of the present disclosure.

As illustrated in FIG. 3, the imaging apparatus 10 includes an imaging unit 11, an image recognition unit 12, a tracking determination unit 13, an angle-of-view control unit 14, an output unit 15, and a storage unit 16.

For example, among the above processing units, the image recognition unit 12, the tracking determination unit 13, and the angle-of-view control unit 14 are processing units that control the tracking determination processing according to the embodiment, and correspond to the determination processing function DV. These processing units corresponding to the determination processing function DV, a central processing unit (CPU), a micro processing unit (MPU), and the like implement various programs (for example, an information processing program) stored in a storage apparatus inside the imaging apparatus 10 by executing the programs using a random access memory (RAM) as a work area. In addition, these processing units are implemented by, for example, an integrated circuit such as an application specific integrated circuit (ASIC) or a field programmable gate array (FPGA).

Although not illustrated in FIG. 3, the imaging apparatus 10 may further include a communication unit that is wirelessly connected to the network N and transmits and receives information to and from the user apparatus 20 and the external apparatus X, for example.

### Imaging Unit 11

The imaging unit 11 images a subject to generate a captured image. The imaging unit 11 is, for example, an image sensor.

### Image Recognition Unit 12

The image recognition unit 12 recognizes a subject of the captured image by analyzing the captured image acquired by the imaging unit 11. Specifically, the image recognition unit 12 recognizes the content of the subject as to who/what is captured on the basis of the captured image.

Furthermore, the image recognition unit 12 may also perform image recognition processing as preprocessing described in step S1 of FIG. 2. Specifically, the image recognition unit 12 may specify the subject to be tracked by matching the feature amount extracted by the analysis of the captured image and the feature amount extracted by the analysis of the registered image, and determine whether or not the specified subject satisfies the start condition of the tracking shooting.

Furthermore, the image recognition unit 12 may also perform image recognition processing in the tracking determination described in step S2 of FIG. 2. Specifically, the image recognition unit 12 may also perform various types of recognition processing of recognizing the state of the subject by analyzing the captured image of the subject (main subject specified by the above method) obtained by tracking shooting.

For example, the image recognition unit 12 may detect the feature amount of the body (for example, a face or a skeleton) of the subject from the captured image of the subject.

Furthermore, the image recognition unit 12 may detect the orientation of the face of the subject and the duration in which the orientation is maintained on the basis of the positional relationship of the face parts (eyes, ears, nose, mouth, or the like) included in the image of the face portion in the captured image of the subject.

Furthermore, the image recognition unit 12 may detect the orientation of the body of the subject and the duration in which the orientation is maintained on the basis of the positional relationship of the body part (Neck, waist, shoulder, and the like) included in the image of the whole-body part in the captured image of the subject.

Furthermore, the image recognition unit 12 may detect the position of the subject on the basis of the captured image of the subject. For example, the image recognition unit 12 may detect the position of the subject based on a characteristic object in the shooting scene in the event EV. According to the example of FIG. 2, examples of the characteristic object in the shooting scene in the event EV include a podium, a teacher's desk, a whiteboard, and the like. The information of the characteristic object may be registered by the user, or may be extracted by image analysis by the image recognition unit 12.

Furthermore, the image recognition unit 12 may detect, on the basis of the captured image of the subject, action content indicating what action the subject is taking and duration in which the action is maintained.

Furthermore, the image recognition unit 12 may detect the motion amount of the subject on the basis of the captured image of the subject. For example, the image recognition unit 12 may detect the motion amount of the subject on the basis of the time-series data of the captured image. Note that, in a case where another person not targeted for tracking shooting is included in the captured image of the subject, the image recognition unit 12 may also estimate the motion amount of the other person.

### Tracking Determination Unit 13

The tracking determination unit 13 determines the necessity of stopping tracking shooting currently being executed on the basis of whether or not the state of the subject on which the tracking shooting is being executed (the main subject specified by the above method) satisfies a predetermined condition. Specifically, in a case where it can be determined that the state of the subject satisfies the tracking stop condition on the basis of the state recognized by the image recognition unit 12, the tracking determination unit 13 determines that there is a need to stop the tracking shooting currently being executed. Specific examples will be given below.

For example, in a case where the subject and the tracking target are estimated to be different (different persons) from each other by comparison between the feature amount of the body of the subject and the feature amount of the body detected from the captured image of the person registered in advance as the tracking target, the tracking determination unit 13 determines that tracking shooting needs to be stopped.

Furthermore, in a case where it is determined that the subject is continuously facing the predetermined direction for a certain period of time or more on the basis of the detection result obtained by detecting the orientation of the body of the subject, the tracking determination unit 13 determines that tracking shooting needs to be stopped. More specifically, in a case where it is determined that the subject is facing the direction of turning back to the imaging apparatus 10 for a certain period of time or more, it is determined that tracking shooting needs to be stopped.

Furthermore, in a case where it is determined that the subject is not present at the position where the original tracking target is estimated to be present (for example, a position within a predetermined range centered on a podium, a position within a predetermined range centered on a teacher's desk, and a position within a predetermined range centered on a whiteboard) on the basis of the detection result of detecting the position of the subject, the tracking determination unit 13 determines that tracking shooting needs to be stopped.

Furthermore, in a case where it is determined that the subject does not continuously exhibit the predetermined action for a certain period of time or more on the basis of the detection result in which the action of the subject is detected, the tracking determination unit 13 determines that tracking shooting needs to be stopped. More specifically, in a case where it is determined that the subject is not speaking for a certain period of time or more, the tracking determination unit 13 determines that tracking shooting needs to be stopped.

Furthermore, in a case where it is determined that the motion amount of the subject is out of the range of the action amount determined in advance according to the motion to be taken by the original tracking target, the tracking determination unit 13 determines that tracking shooting needs to be stopped. Note that the tracking determination unit 13 may compare the motion amount of another person with the motion amount of the subject in a case where another person not targeted for tracking shooting is included in the captured image of the subject, and may determine that tracking shooting needs to be stopped in a case where it is estimated that the motion to be taken by the original tracking target is not performed by the subject on the basis of the comparison result. For example, in use cases such as a music live show, a sport, and a lecture, if there is statistics that the range of the motion amount of the original tracking target will be a predetermined range (for example, the threshold value TH1 or more), the tracking may be stopped in a case where the motion amount corresponding to the subject falls below the range (for example, in a case where the motion is slow and the motion amount of the tracking target is smaller than the threshold value TH1). Furthermore, in another use case, if there is statistics that the range of the motion amount of the original tracking target will be a predetermined range (for example, the threshold value TH2 or less), the tracking target may be stopped in a case where the motion amount corresponding to the subject is out of the range (for example, in a case where the motion is too large and the motion amount of the tracking target is larger than the threshold value TH2).

### Angle-of-View Control Unit 14

The angle-of-view control unit 14 stops the tracking shooting of the subject according to the determination result of the necessity. Specifically, in a case where it is determined that tracking shooting needs to be stopped, the angle-of-view control unit 14 stops the tracking shooting of the subject and performs control so that the current imaging range (for example, angle of view A2 in FIG. 2) focused on the subject can be switched to a wider imaging range (for example, angle of view A1 in FIG. 2) not focused on the subject. Note that, as described with reference to FIG. 2, the angle-of-view control unit 14 may not necessarily change the angle of view to the angle of view A1 at which an overhead view image can be captured. For example, the angle-of-view control unit 14 may change the angle of view to the angle of view A3 by zooming out to the angle of view A3 at which main objects present around the subject enter the imaging range.

### Output Unit 15

The output unit 15 outputs the captured image captured by the imaging unit 11 to a predetermined device. For example, the output unit 15 may output the captured image to a front screen (not illustrated) of its own apparatus (imaging apparatus 10).

In addition, the output unit 15 may output the captured image to a display screen (not illustrated) of the user apparatus 20 or the external apparatus X.

### Storage Unit 16

The storage unit 16 stores the captured image captured by the imaging unit 11. Furthermore, the information processing program according to the embodiment may also be stored in the storage unit 16.

### 4. Specific Example of Information Processing

### 4-1. Specific Example of Entire Information Processing

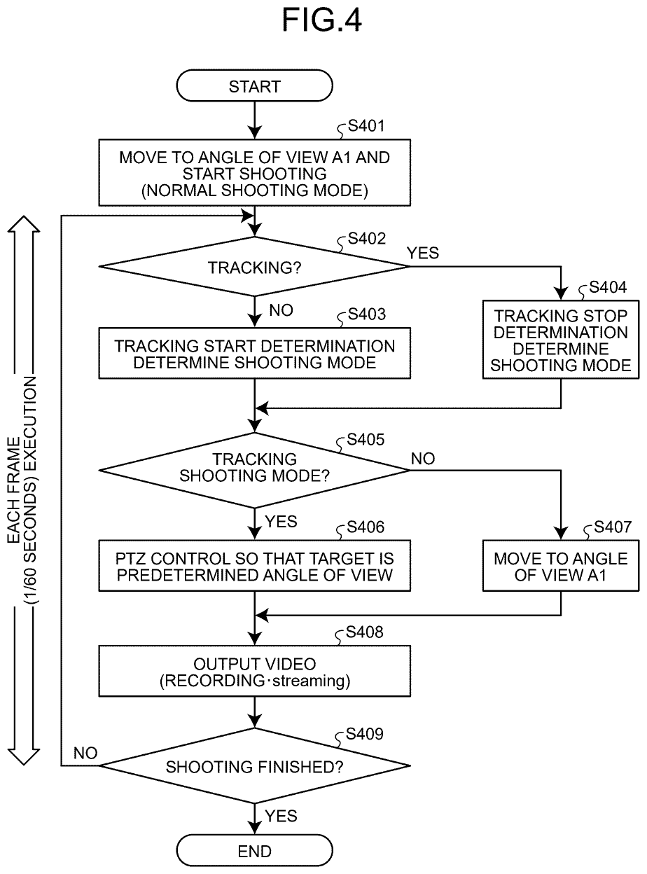

Next, information processing executed by the imaging apparatus 10 illustrated in FIG. 3 as the information processing apparatus according to the embodiment of the present disclosure will be described. FIG. 4 is a flowchart illustrating an overall flow of information processing executed by the imaging apparatus 10.

First, the angle-of-view control unit 14 controls the imaging unit 11 to start capturing the state of the event EV at the angle of view A1 for preprocessing (for example, image recognition processing for specifying a tracking target) related to the tracking determination processing. That is, the angle-of-view control unit 14 causes the imaging unit 11 to shift to the normal shooting mode and start imaging (step S401). The angle of view A1 may be a wide range of angle of view suitable for specifying the tracking target.

The imaging unit 11 captures a captured image of one frame at a specific timing via the lens according to the start of shooting in the normal shooting mode.

The angle-of-view control unit 14 determines whether the imaging unit 11 is tracking the subject in the captured image (step S402). That is, the angle-of-view control unit 14 determines whether the shooting mode is the normal shooting mode or the tracking shooting mode.

In a case where it is determined that the subject is not being tracked (step S402; No), that is, in the normal shooting mode, the image recognition unit 12 and the angle-of-view control unit 14 make a tracking start determination that is a determination as to whether or not to start tracking determination processing (step S403). First, the image recognition unit 12 specifies a subject to be tracked from among subjects in captured images by performing image recognition processing on the captured images in time series. For example, in a case where an image of a person to be tracked is registered in advance, the image recognition unit 12 may specify the subject to be tracked by matching (matching with a feature amount) between the registered image and an image of each subject included in the captured image that has been captured. As described above, in a case where the subject to be tracked is specified, the angle-of-view control unit 14 may determine to start the tracking determination processing.

Furthermore, in a case where the tracking target is specified, the angle-of-view control unit 14 performs control to start tracking shooting of a main subject that is a subject specified as the tracking target. For example, the angle-of-view control unit 14 may control the imaging unit 11 to switch to the tracking shooting mode (that is, the imaging mode is determined as the tracking shooting mode) and start tracking shooting at a time point when the main subject satisfies a specific condition. For example, in a case where it is determined that the main subject satisfies the start condition of the tracking shooting on the basis of the image recognition result for the captured image captured as needed via the lens, the angle-of-view control unit 14 controls the imaging unit 11 to switch from the angle of view A1 to the angle of view A2 focused on the main subject and capture an image. In this manner, in step S403, the imaging apparatus 10 specifies the subject to be tracked and determines to start shooting in the tracking shooting mode. Note that, in a case where the tracking target cannot be specified, the imaging apparatus 10 determines to continue imaging in the normal shooting mode.

On the other hand, in a case where the tracking determination unit 13 recognizes that the imaging unit 11 is in the middle of executing tracking shooting under the control of the angle-of-view control unit 14 (step S402; Yes), that is, in the tracking shooting mode, tracking determination processing using the tracking stop condition is performed (step S404). Here, in a case where it is determined that there is a need to stop tracking in the tracking determination processing, the angle-of-view control unit 14 determines the normal shooting mode as the shooting mode. Furthermore, in a case where it is determined that there is no need to stop tracking, the angle-of-view control unit 14 determines the tracking shooting mode as the shooting mode.

On the basis of the result of the tracking start determination in step S403 or the result of the tracking determination processing in step S404, the angle-of-view control unit 14 determines whether the currently determined shooting mode is the tracking shooting mode (step S405). For example, in a case where it is determined that there is a need to stop tracking on the basis of the determination result by the tracking determination unit 13, the shooting mode is determined to be the normal shooting mode, and in a case where it is determined that there is no need to stop tracking, the shooting mode is determined to be the tracking shooting mode.

In a case where the normal shooting mode is determined, that is, in a case where there is a need to stop tracking (step S405; No), the tracking shooting is stopped, and the angle-of-view control unit 14 controls the imaging unit 11 to shoot the overhead view image at the original angle of view A1 (step S407).

On the other hand, in a case where the tracking shooting mode is determined, that is, in a case where there is no need to stop tracking (step S405; Yes), the angle-of-view control unit 14 causes the tracking shooting of the main subject specified in step S403 to be continued (step S406). For example, the angle-of-view control unit 14 may perform PTZ control so that the main subject fits within a predetermined angle of view (for example, angle of view A2).

Furthermore, the output unit 15 outputs a video (for example, streaming video) generated from the captured image during the period in which the event EV has been held, which is the captured image accumulated in the storage unit 16, to the designated destination (step S408).

The angle-of-view control unit 14 determines whether or not the shooting of the event EV has ended. For example, the angle-of-view control unit 14 determines whether or not shooting is finished on the basis of whether not an instruction to finish shooting is input to the imaging apparatus 10 (step S409). That is, in a case where an instruction to finish shooting is input, the angle-of-view control unit 14 determines that shooting is finished. Furthermore, for example, the angle-of-view control unit 14 may determine the end of the event EV on the basis of the image recognition result with respect to the captured image and the notification indicating the end of the event EV received from the user apparatus 20 (input by which the user reports the end of the event EV), and determine that the imaging has ended in a case where it is determined that the event EV has ended.

In a case where shooting is finished (step S409; Yes), the angle-of-view control unit 14 terminates the information processing in the shooting of the event EV. On the other hand, while the shooting is not finished (step S409; No), the angle-of-view control unit 14 switches the process to step S402 for the next frame.

Note that the processing in steps S402 to S409 is not limited to being performed every frame, and may be performed every several frames.

### 4-2. Specific Example of Tracking Determination Processing

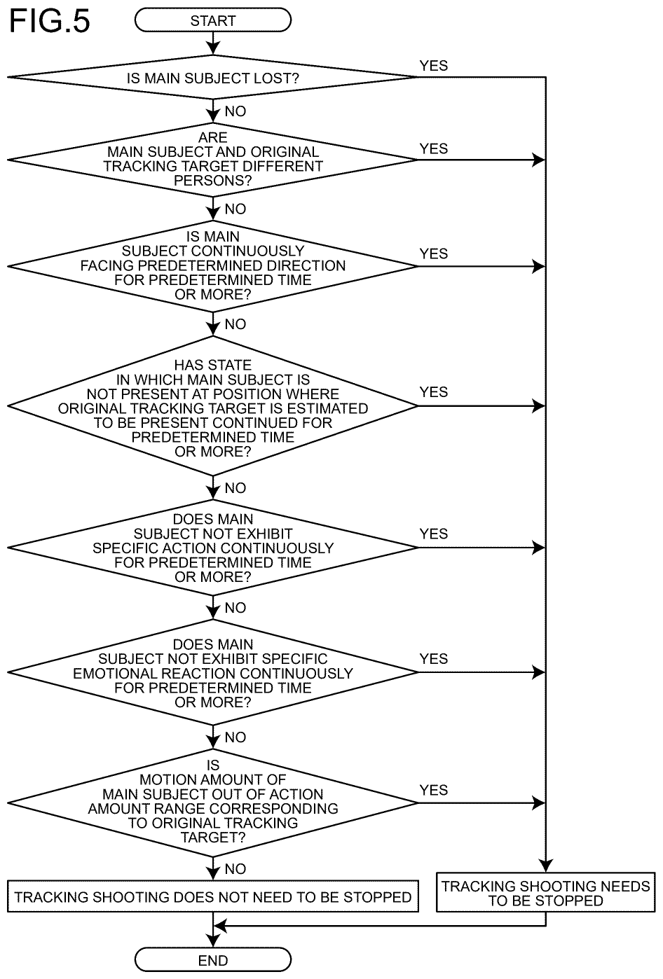

Next, tracking determination processing executed by the imaging apparatus 10 in step S404 in FIG. 4 will be specifically described. FIG. 5 is a flowchart illustrating a flow of tracking determination processing executed by the imaging apparatus 10. Note that FIG. 5 illustrates the tracking determination processing in seven stages in a case where each of the seven tracking stop conditions is used, but which tracking stop condition is used and in which order the tracking determination processing is performed is not limited. In addition, all seven tracking stop conditions are not necessarily used, and at least one condition is only required to be used.

For example, the tracking determination unit 13 determines whether or not the main subject has been lost in tracking on the basis of the result of the image recognition processing on the captured image obtained by tracking shooting. For example, the tracking determination unit 13 may determine that the main subject is lost in a case where the main subject is not captured in the captured image (within the shooting range) for a predetermined time or more, and may determine that there is no loss of the main subject in a case where the main subject is captured in the captured image (within the shooting range). Then, in a case where the main subject is lost (Yes), the tracking determination unit 13 recognizes that the tracking stop condition is satisfied and determines that tracking shooting needs to be stopped. On the other hand, in a case where there is no loss of the main subject (No), the tracking determination unit 13 recognizes that the tracking stop condition is not satisfied and determines that it is not necessary to stop tracking shooting. Specific examples of losing the main subject include a case where the main subject goes out of the shooting range in order to pick up an object dropped by the main subject, a case where the moving speed of the main subject is faster than the tracking speed and the main subject goes out of the shooting range, a case where the main subject has a posture, a hairstyle, or clothes that cannot be recognized by the image recognition unit 12, and a case where the illumination of the shooting environment has brightness where the main subject cannot be recognized by the image recognition unit 12.

In addition, the tracking determination unit 13 determines whether or not the main subject and the original tracking target are different persons by comparing the feature amount (for example, the face feature amount, the skeleton feature amount, and the wearing object feature amount) extracted from the captured image of the main subject with the feature amount extracted from the captured image of the person registered in advance as the tracking target. For example, the tracking determination unit 13 may determine that the main subject and the original tracking target are different persons in a case where both the feature amounts do not match, and may determine that the main subject and the original tracking target are the same person in a case where both the feature amounts match. Then, in a case where the main subject and the original tracking target are different persons (Yes), the tracking determination unit 13 recognizes that the tracking stop condition is satisfied and determines that tracking shooting needs to be stopped. On the other hand, in a case where the main subject and the original tracking target are the same person (No), the tracking determination unit 13 recognizes that the tracking stop condition is not satisfied and determines that it is not necessary to stop tracking shooting.

Furthermore, the tracking determination unit 13 determines whether or not the main subject is continuously facing a predetermined direction for a predetermined time or more on the basis of the orientation of the body (for example, the orientation of the face or the orientation of the whole body) of the subject detected from the captured image of the main subject and the duration in which the orientation is maintained. The predetermined direction here may be appropriately changed according to the shooting scene of the event EV. For example, assuming that a teacher teaches a student a shooting scene of the event EV in a university class, the original tracking target (teacher) should face the direction of the imaging apparatus 10 (that is, the front), and in a case where the teacher is facing the rear side (in a case where the back of the head of the main subject is captured), it is suspected that the current main subject is not the original tracking target. Therefore, if the event EV is a scene in which a teacher teaches a student in a university class, a predetermined direction=an opposite direction (that is, the rear side) with the direction of the imaging apparatus 10 as the front may be defined.

In addition, there is a case where the main subject basically faces a certain direction, but faces another direction for a moment. In such a case, control may be performed by the imaging apparatus 10 so as not to reset the duration in a state where the face is oriented in a certain direction and switch to the measurement of the duration in a state where the face is oriented in another direction cannot be performed.

Returning to the description, in a case where the main subject is facing a predetermined direction (for example, a direction not suitable for the shooting scene of the event EV: for example, backward) continuously for a predetermined time or more (Yes), in other words, in a case where the face of the main subject cannot be continuously detected, the tracking determination unit 13 recognizes that the tracking stop condition is satisfied and determines that tracking shooting needs to be stopped. On the other hand, in a case where the main subject continues to face the appropriate direction (No), the tracking determination unit 13 recognizes that the tracking stop condition is not satisfied and determines that it is not necessary to stop tracking shooting.

Furthermore, the tracking determination unit 13 determines whether or not a state in which the main subject is not present at the position where the original tracking target is estimated to be present has continued for a predetermined time or more on the basis of the position of the main subject detected from the captured image of the main subject (the position of the subject based on the characteristic object in the shooting scene in the event EV) and the duration in which the main subject is present at this position. For example, assuming that a teacher teaches a student a shooting scene of the event EV in a university class, an original tracking target (teacher) should be within a range of a podium, around a teacher's desk, within a range of a whiteboard, or the like, and in a case where the teacher is at a position not including these objects (for example, a periphery of a student desk) , it is suspected that the current main subject is not the original tracking target. Therefore, if the event EV is a scene in which a teacher teaches a student in a university class, a podium, a teacher's desk, a whiteboard, and the like may be defined as the object.

In addition, there is a case where the main subject is basically around a characteristic object, but temporarily moves to a position away from the object. In such a case, control may be performed by the imaging apparatus 10 so as not to reset the duration in the state of being around the object and switch to the measurement of the duration at a distant position.

Returning to the description, in a case where a state in which the main subject is not present at the position where the original tracking target is estimated to be present continues for a predetermined time or more (Yes), the tracking determination unit 13 recognizes that the tracking stop condition is satisfied and determines that tracking shooting needs to be stopped. On the other hand, in a case where the main subject is continuously present at the position where the original tracking target is estimated to be present (No), the tracking determination unit 13 recognizes that the tracking stop condition is not satisfied and determines that it is not necessary to stop tracking shooting.

In addition, the tracking determination unit 13 determines whether or not the main subject is in a state of not exhibiting a specific action continuously for a predetermined time or more on the basis of the action of the main subject detected from the captured image of the main subject and the duration in which the action is maintained. For example, assuming that a teacher teaches a student a shooting scene of the event EV in a university class, an original tracking target (teacher) should take an action of speaking to the student, and in a case where the original tracking target is not speaking, it is suspected that the current main subject is not the original tracking target. Therefore, if the event EV is a scene in which a teacher teaches a student in a university class, an action to talk to the others may be defined as a specific action.

In addition, there is a case where, although the main subject basically continues speaking, the main subject temporarily stops speaking. In such a case, control may be performed by the imaging apparatus 10 so as not to reset the duration in the talking state and switch to the measurement of the duration in the non-talking state cannot be performed.

Returning to the description, in a case where the main subject does not exhibit a specific action continuously for a predetermined time or more (Yes), the tracking determination unit 13 recognizes that the tracking stop condition is satisfied and determines that tracking shooting needs to be stopped. On the other hand, in a case where the main subject continuously exhibits a specific action (No), the tracking determination unit 13 recognizes that the tracking stop condition is not satisfied, and determines that it is not necessary to stop tracking shooting.

Furthermore, the tracking determination unit 13 determines whether or not the main subject does not exhibit a specific emotional reaction continuously for a predetermined time or more on the basis of the emotional reaction of the main subject detected from the captured image of the main subject. For example, assuming that a teacher teaches a student a shooting scene of the event EV in a university class, an original tracking target (teacher) should periodically exhibit an emotional reaction such as smiling or angry, and in a case where the original tracking target is not exhibiting, it is suspected that the current main subject is not the original tracking target. Therefore, if the event EV is a scene in which a teacher teaches a student in a university class, smiling/angry may be defined as an emotional reaction.

In a case where the main subject does not exhibit a specific emotional reaction continuously for a predetermined time or more (Yes), the tracking determination unit 13 recognizes that tracking tail stop condition is satisfied and determines that tracking shooting needs to be stopped. On the other hand, in a case where the main subject periodically exhibits a specific emotional reaction (No), the tracking determination unit 103 recognizes that the tracking stop condition is not satisfied and determines that it is not necessary to stop tracking shooting.

Furthermore, the tracking determination unit 103 determines whether or not the motion amount of the main subject detected from the captured image of the main subject is out of the range of the action amount determined in advance according to the motion to be taken by the original tracking target. For example, it is assumed that statistics indicating that the motion amount of the original tracking target is conceptually in the range of AC1 to AC5 (for example, the threshold value TH1 or more) is obtained in the shooting scene of the event EV. In such an example, in a case where the motion amount of the main subject detected from the captured image of the subject is out of the motion amount range AC1 to AC5 (for example, smaller than the threshold value TH1) (Yes), the tracking determination unit 103 recognizes that the tracking stop condition is satisfied and determines that tracking shooting needs to be stopped. On the other hand, in a case where the motion amount of the main subject detected from the captured image of the subject is within the motion amount range AC1 to AC5 (for example, greater than or equal to the threshold value TH1) (No), the tracking determination unit 103 recognizes that the tracking stop condition is not satisfied, and determines that it is not necessary to stop tracking shooting.

Note that, although not illustrated, in a case where the motion amount of another person not targeted for tracking shooting is also detected as the other person is included in the captured image of the main subject, the tracking determination unit 103 may determine whether or not the motion to be taken by the original tracking target is being performed by the main subject by comparing the motion amount of the other person with the motion amount of the main subject. For example, the tracking determination unit 13 may determine that the motion to be taken by the original tracking target is not performed by the main subject in a case where the motion amount of the main subject is smaller than the motion amount of the other person, and may determine that the motion to be taken by the original tracking target is performed by the main subject in a case where the motion amount of the main subject is larger than the motion amount of the other person.

Then, in a case where the motion amount of the main subject is small (Yes), the tracking determination unit 13 recognizes that the tracking stop condition is satisfied and determines that tracking shooting needs to be stopped. On the other hand, in a case where the motion amount of the main subject is large (No), the tracking determination unit 13 recognizes that the tracking stop condition is not satisfied, and determines that it is not necessary to stop tracking

### 5. Modification

The information processing apparatus according to the embodiment may be implemented in a mode different from the above example. Therefore, a modification of the information processing apparatus according to the embodiment will be described below.

### 5-1. Tracking Shooting of Plurality of Subjects

For example, there is a case where the imaging apparatus 10 performs tracking shooting so as to keep a plurality of subjects within the angle of view. For example, in a case where matching can be made between each person and a person in the captured image by registering images of a plurality of persons to be tracked in advance, or in a case where a plurality of persons is designated as tracking targets via the user apparatus 20, the imaging apparatus 10 performs tracking shooting so as to keep the plurality of subjects within the angle of view.

In such a case, the tracking determination unit 13 may determine whether or not the state of each of the plurality of main subjects satisfies the tracking stop condition, and determine the necessity of stopping tracking shooting for the plurality of main subjects on the basis of the relationship between the determination results among the main subjects.

For example, in a case where at least one of the plurality of main subjects satisfies the tracking stop condition, the tracking determination unit 13 determines that tracking shooting needs to be stopped for the plurality of main subjects. As a specific example, in a case where the person P1 is out of the imaging range in a state where shooting is performed so as to be included in the angle of view A2 of the persons P1 and P2 who discuss with each other on the stage, the tracking determination unit 13 determines that tracking shooting needs to be stopped.

As another example, in a case where all of the plurality of main subjects satisfy the tracking stop condition, the tracking determination unit 13 determines that tracking shooting needs to be stopped for the plurality of main subjects. For example, the tracking determination unit 13 determines that tracking shooting needs to be stopped in a case where both of the persons P1 and P2 are out of the imaging range in a state where shooting is performed so as to be included in the angle of view A2 of the persons P1 and P2 who discuss with each other on the stage. On the other hand, if at least one of the plurality of main subjects does not satisfy the tracking stop condition, tracking shooting for all the main subjects including the main subjects satisfying the tracking stop condition is continued.

As still another example, even if one of the plurality of main subjects satisfies the tracking stop condition, the tracking determination unit 13 may determine that it is not necessary to stop tracking shooting for the plurality of main subjects until the remaining main subjects satisfy the tracking stop condition. For example, even if the person P1 is out of the imaging range in a state where shooting is performed so as to be included in the angle of view A2 of the persons P1 and P2 who discuss with each other on the stage, the tracking determination unit 13 may continue the tracking shooting until the person P2 is out of the imaging range.

### 5-2. Another Configuration of Information Processing Apparatus

In the above embodiment, an example has been described in which the tracking determination processing is performed by the determination processing function DV of the imaging apparatus 10. That is, in the above embodiment, the tracking determination processing in a case where the imaging apparatus 10 is implemented as the information processing apparatus according to the embodiment has been described. However, the tracking determination processing may be performed by the external apparatus X communicably connected to the imaging apparatus 10. In such a case, the determination processing function DV is equipped in the external apparatus X.

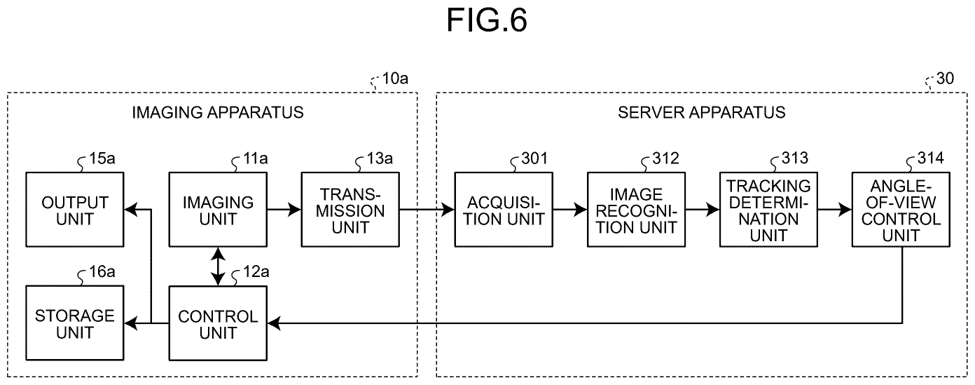

As described with reference to FIG. 1, the external apparatus X implemented as the information processing apparatus according to the embodiment instead of the imaging apparatus 10 may be a notebook PC, a desktop PC, a server apparatus, or the like. However, FIG. 6 illustrates an example in which a server apparatus 30 is implemented as the information processing apparatus according to the embodiment instead of the imaging apparatus 10. FIG. 6 is a diagram illustrating an example (1) of a schematic configuration of an information processing apparatus in a modification according to the embodiment.

Note that, in a case where the tracking determination processing is performed on the server apparatus 30 side, the determination processing function DV may not be equipped in the imaging apparatus 10. Therefore, FIG. 6 illustrates an example in which an imaging apparatus 10a not having the determination processing function DV and the server apparatus 30 are communicably connected.

### Regarding Imaging Apparatus 10a

As illustrated in FIG. 6, the imaging apparatus 10a may include an imaging unit 11a, a control unit 12a, a transmission unit 13a, an output unit 15a, and a storage unit 16a.

The imaging unit 11a images a subject to generate a captured image. The imaging unit 11a is, for example, an image sensor. The control unit 12a controls imaging by the imaging unit 11a, and transmits a captured image obtained by imaging according to the control to the output unit 15a and the storage unit 16a.

The transmission unit 13a transmits the captured image captured by the imaging unit 11a to the server apparatus 30.

### Regarding Server Apparatus 30

As illustrated in FIG. 6, the server apparatus 30 is communicably connected to the imaging apparatus 10a having an imaging function, and may include an acquisition unit 301, an image recognition unit 312, a tracking determination unit 313, and an angle-of-view control unit 314.

The acquisition unit 301, the image recognition unit 312, the tracking determination unit 313, and the angle-of-view control unit 314 are processing units that control tracking determination processing, and correspond to the determination processing function DV. These processing units corresponding to the determination processing function DV are processing units implemented by executing various programs (for example, an information processing program) stored in a storage apparatus (not illustrated) inside the server apparatus 30 using a RAM as a work area by a CPU, an MPU, or the like. In addition, these processing units are implemented by, for example, an integrated circuit such as an ASIC or an FPGA.

The acquisition unit 301 acquires a captured image obtained by tracking shooting on the imaging apparatus 10a side. The captured image may be transmitted by the transmission unit 13a of the imaging apparatus 10a.

The image recognition unit 312 is a processing unit corresponding to the image recognition unit 12 in FIG. 3, and performs image recognition processing on the captured image. For example, the image recognition unit 312 may specify the main subject by analyzing the captured image obtained by the overhead view shooting on the imaging apparatus 10a side. Furthermore, the image recognition unit 312 may recognize the state of the main subject by analyzing the captured image of the main subject obtained by tracking shooting on the imaging apparatus 10a side.

The tracking determination unit 313 is a processing unit corresponding to the tracking determination unit 13 in FIG. 3, and performs tracking determination processing according to the embodiment. Specifically, the tracking determination unit 313 determines the necessity of stopping tracking shooting currently being executed on the basis of whether or not the state of the main subject satisfies the tracking stop condition. More specifically, in a case where it can be determined that the state of the main subject satisfies the tracking stop condition on the basis of the state recognized by the image recognition unit 312, the tracking determination unit 313 determines that there is a need to stop the tracking shooting currently being executed.

The angle-of-view control unit 314 is a processing unit corresponding to the angle-of-view control unit 14 in FIG. 3, and stops the tracking shooting of the main subject according to the determination result of the necessity of the tracking stop. In the example of FIG. 6, in a case where it is determined that tracking shooting needs to be stopped, the angle-of-view control unit 314 controls the imaging apparatus 10a (control unit 12a) to stop the tracking shooting of the main subject and switch the current imaging range (angle of view A2) focused on the main subject to a wider imaging range (angle of view A1) not focused on the main subject for shooting.

Furthermore, in a case where it is determined that the tracking shooting does not need to be stopped, the angle-of-view control unit 314 may also perform processing of controlling the imaging apparatus 10a (control unit 12a) to perform tracking shooting of the main subject specified by the image recognition unit 312. The control unit 12a controls the imaging unit 11a to perform tracking shooting of the main subject on the basis of the information received from the angle-of-view control unit 314.

### Summary of Present Modification

For example, in the example of FIG. 6, the imaging apparatus 10a only needs to provide the captured image to the server apparatus 30, and the tracking determination processing itself is performed on the server apparatus 30 side. According to such a configuration, for example, even the imaging apparatus (imaging apparatus 10a) having no calculation resource for the old model can be used at the site of the tracking determination processing, and thus, for example, the user does not need to introduce a high-performance imaging apparatus. That is, there is an advantage that the introduction cost is not required.

### 5-3. Another Configuration of Information Processing Apparatus

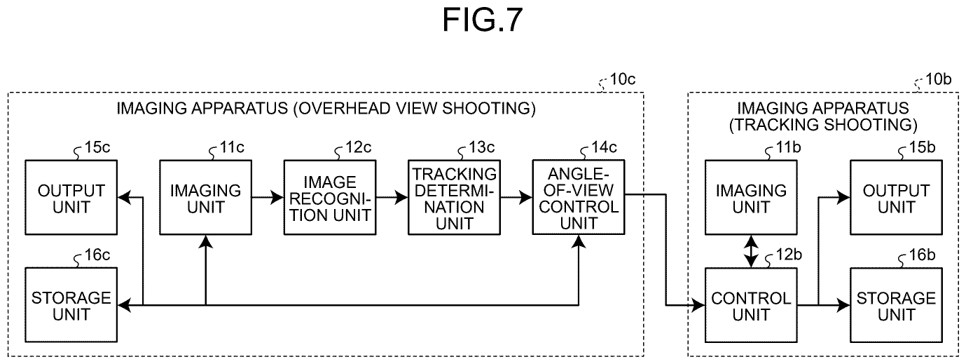

At a shooting site, multi-camera cooperation for acquiring a plurality of videos having different angles and angles of view may be adopted, for example, by cooperating a plurality of imaging apparatuses 10 having different shooting types from each other. FIG. 7 illustrates an example in which an imaging apparatus 10b that performs tracking shooting and an imaging apparatus 10c that performs overhead view shooting are cooperated as an example of multi-camera cooperation.

Therefore, tracking determination processing in a case where a plurality of imaging apparatuses 10 (imaging apparatuses 10b and 10c) having different shooting types cooperates will be described with reference to FIG. 7. FIG. 7 is a diagram illustrating an example (2) of a schematic configuration of an information processing apparatus in a modification according to the embodiment. As illustrated in FIG. 7, the imaging apparatus 10b that does not have the determination processing function DV and is specialized only for tracking shooting and the imaging apparatus 10b having the determination processing function DV may be multi-linked.

### Regarding Imaging Apparatus 10B

As illustrated in FIG. 6, the imaging apparatus 10b may include an imaging unit 11b, a control unit 12b, an output unit 15b, and a storage unit 16b.

The imaging unit 11b images a subject to generate a captured image. The imaging unit 11b is, for example, an image sensor. The control unit 12b controls imaging by the imaging unit 11b, and transmits a captured image obtained by imaging according to the control to the output unit 15b and the storage unit 16b. For example, the control unit 12b controls the imaging unit 11b to perform tracking shooting of the main subject on the basis of the information received from an angle-of-view control unit 14c of the imaging apparatus 10c.

### Regarding Imaging Apparatus 10c

As illustrated in FIG. 7, the imaging apparatus 10c is communicably connected to the imaging apparatus 10b having an imaging function, and may include an imaging unit 11c, an image recognition unit 12c, a tracking determination unit 13c, an angle-of-view control unit 14c, an output unit 15c, and a storage unit 16c.

For example, among the above processing units, the image recognition unit 12c, the tracking determination unit 13c, and the angle-of-view control unit 14c are processing units that control the tracking determination processing according to the embodiment, and correspond to the determination processing function DV. These processing units corresponding to the determination processing function DV are processing units implemented by the CPU, the MPU, or the like executing various programs (for example, an information processing program) stored in the storage unit 16c inside the imaging apparatus 10c using the RAM as a work area. In addition, these processing units are implemented by, for example, an integrated circuit such as an ASIC or an FPGA.

The imaging unit 11c images a subject to generate a captured image. The imaging unit 11c is, for example, an image sensor. The imaging unit 11c may perform the overhead view shooting at the angle of view according to the control of the angle-of-view control unit 14c.

The image recognition unit 12c is a processing unit corresponding to the image recognition unit 12 in FIG. 3, and performs image recognition processing on the captured image. For example, the image recognition unit 12c may specify the main subject by analyzing the captured image obtained by the overhead view shooting of the own apparatus (imaging apparatus 10c). At this time, the angle-of-view control unit 14c may instruct the control unit 12b to track and shoot the main subject specified by the image recognition unit 12c. In such a case, the control unit 12b controls the imaging unit 11b to perform tracking shooting of the main subject on the basis of the information regarding the main subject received from the angle-of-view control unit 14c.

Furthermore, the image recognition unit 12c may recognize the state of the main subject by analyzing the captured image including the main subject obtained by the overhead view shooting.

The tracking determination unit 13c is a processing unit corresponding to the tracking determination unit 13 in FIG. 3, and performs tracking determination processing according to the embodiment. Specifically, the tracking determination unit 13c determines the necessity of stopping tracking shooting currently being executed on the basis of whether or not the state of the main subject satisfies the tracking stop condition. More specifically, in a case where it can be determined that the state of the main subject satisfies the tracking stop condition on the basis of the state recognized by the image recognition unit 12c, the tracking determination unit 13c determines that there is a need to stop the tracking shooting currently being executed.

The angle-of-view control unit 14c is a processing unit corresponding to the angle-of-view control unit 14 in FIG. 3, and stops the tracking shooting of the main subject according to the determination result of the necessity of the tracking stop. In the example of FIG. 7, in a case where it is determined that tracking shooting needs to be stopped, the angle-of-view control unit 14c stops the tracking shooting of the main subject, and controls the imaging apparatus 10b (control unit 12b) to switch from the current imaging range (angle of view A2) focused on the main subject to a wider imaging range (angle of view A1) not focused on the main subject for shooting.

Furthermore, the angle-of-view control unit 14c may control the overhead view shooting by the imaging unit 11c and transmit the captured image obtained by imaging according to the control to the output unit 15b and the storage unit 16b.

### Summary of Present Modification

In the example of FIG. 7, the imaging apparatus 10b side that performs the overhead view shooting is caused to perform the tracking determination processing, and the angle-of-view control according to the determination result is performed on the imaging apparatus 10c. In such a configuration, since all of the processing from the image recognition processing on the overhead view captured image capturing the entire event EV to the tracking determination processing based on the recognition result is performed by the imaging apparatus 10b, there is an advantage that the conventional imaging apparatus (imaging apparatus 10c) having the tracking shooting function but not having sufficient calculation resources to be subjected to the tracking determination processing can be used as it is.

### 5-4. Another Configuration of Information Processing Apparatus

FIG. 7 illustrates an example in which a series of tracking determination processing is performed on the imaging apparatus 10b side that performs overhead view shooting, so that the imaging apparatus 10c that performs tracking shooting may perform tracking shooting by receiving control according to a determination result from the imaging apparatus 10b. However, the tracking determination function DV may be distributed among the plurality of imaging apparatuses 10 having different shooting types, so that the tracking determination processing may be implemented in cooperation of both the imaging apparatuses 10.

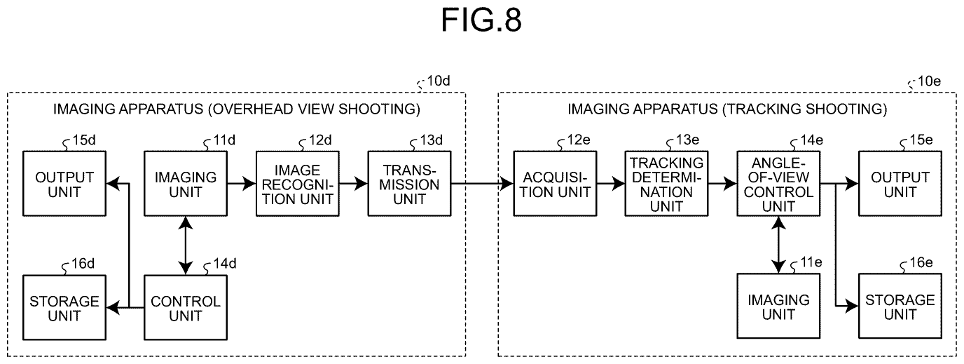

FIG. 8 illustrates an example in which an imaging apparatus 10d that performs overhead view shooting and an imaging apparatus 10e that performs tracking shooting are cooperated as an example of multi-camera cooperation.

Therefore, with reference to FIG. 8, tracking determination processing in a case where a plurality of imaging apparatuses 10 (imaging apparatuses 10d and 10e) having different shooting types cooperates will be described. FIG. 8 is a diagram illustrating an example (3) of a schematic configuration of an information processing apparatus in a modification according to the embodiment. According to the example of FIG. 8, the image recognition function may be included in the imaging apparatus 10d, and the tracking determination processing function using the tracking stop condition may be included in the imaging apparatus 10e. As a result, the imaging apparatus 10e performs tracking determination processing on the basis of state information indicating a state of the main subject recognized by the imaging apparatus 10d and obtained as an analysis result for the captured image obtained by the overhead view shooting by the imaging apparatus 10d.

### Regarding Imaging Apparatus 10d

As illustrated in FIG. 8, the imaging apparatus 10d may include an imaging unit 11d, an image recognition unit 12d, a transmission unit 13d, a control unit 14d, an output unit 15d, and a storage unit 16d.

The imaging unit 11d images a subject to generate a captured image. The imaging unit 11d is, for example, an image sensor.

The image recognition unit 12d is a processing unit corresponding to the image recognition unit 12 in FIG. 3, and performs image recognition processing on the captured image. For example, the image recognition unit 12d may specify the main subject by analyzing the captured image obtained by the overhead view shooting of the own apparatus (imaging apparatus 10d). Furthermore, the image recognition unit 12d may recognize the state of the main subject by analyzing the captured image including the main subject obtained by the overhead view shooting.

The transmission unit 13d transmits information regarding the recognition result by the image recognition unit 12d to the imaging apparatus 10e. For example, the transmission unit 13d may cause the imaging apparatus 10e to execute tracking shooting of the main subject by transmitting information indicating the main subject (information indicating who the main subject is) to the imaging apparatus 10e. Furthermore, the transmission unit 13d may cause the imaging apparatus 10e to execute tracking determination processing based on the state of the main subject by transmitting state information indicating the state of the main subject to the imaging apparatus 10e. Note that the state information is, for example, information indicating the face of the main subject or the orientation of the entire body, information indicating a predetermined action, or the like.

The control unit 14d may control the overhead view shooting by the imaging unit 11d and transmit a captured image obtained by imaging according to the control to the output unit 15d and the storage unit 16d.

### Regarding Imaging Apparatus 10e

As illustrated in FIG. 8, the imaging apparatus 10e may include an imaging unit 11e, an acquisition unit 12e, a tracking determination unit 13e, an angle-of-view control unit 14e, an output unit 15e, and a storage unit 16e.

The imaging unit 11e images a subject to generate a captured image. The imaging unit 11e is, for example, an image sensor. The imaging unit 11e may perform tracking shooting at an angle of view according to the control of the angle-of-view control unit 14e.

The acquisition unit 12e acquires the information transmitted by the transmission unit 13d of the imaging apparatus 10d. For example, the acquisition unit 12e may acquire information indicating the main subject and state information indicating the state of the main subject.

The tracking determination unit 13e is a processing unit corresponding to the tracking determination unit 13 in FIG. 3, and performs tracking determination processing according to the embodiment. Specifically, the tracking determination unit 13e determines the necessity of stopping tracking shooting currently being executed, on the basis of whether or not the state (the state of the main subject) indicated by the state information acquired by the acquisition unit 12e satisfies the tracking stop condition. More specifically, in a case where it can be determined that the state of the main subject satisfies the tracking stop condition, the tracking determination unit 13e determines that there is a need to stop the tracking shooting currently being executed.

The angle-of-view control unit 14e is a processing unit corresponding to the angle-of-view control unit 14 in FIG. 3, and stops the tracking shooting of the main subject according to the determination result of the necessity of the tracking stop. In the example of FIG. 8, in a case where it is determined that tracking shooting needs to be stopped, the angle-of-view control unit 14e controls the imaging unit 11e to stop tracking shooting of the main subject.

In addition, the angle-of-view control unit 14e may control tracking shooting by the imaging unit 11e and transmit a captured image obtained by imaging according to the control to the output unit 15e and the storage unit 16e.

(Summary of Present Modification) In the example of FIG. 8, the tracking determination function DV is distributed between the imaging apparatus 10d that performs the overhead view shooting and the imaging apparatus 10e that performs the tracking shooting, so that the tracking determination processing is implemented in cooperation of both the imaging apparatuses 10. In such a configuration, since the imaging apparatus 10d that excels in image recognition processing in that an overhead view captured image capturing the entire event EV can be acquired and the imaging apparatus 10e that excels in tracking determination processing in that tracking shooting is performed are combined, it is possible to determine whether or not to stop tracking shooting of the main subject with higher accuracy.

### 6. Hardware Configuration

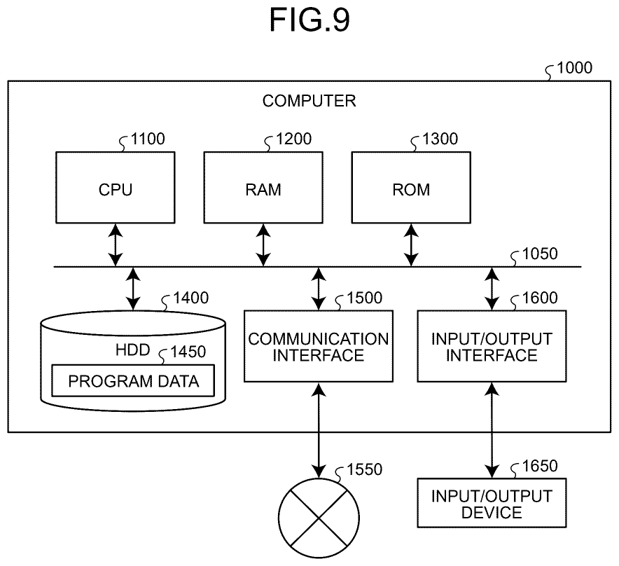

A hardware configuration example of a computer corresponding to the information processing apparatus (the imaging apparatus 10 or the like) according to the above-described embodiment will be described with reference to FIG. 9. FIG. 9 is a block diagram illustrating a hardware configuration example of a computer corresponding to the information processing apparatus according to the embodiment of the present disclosure. Note that FIG. 9 illustrates an example of a hardware configuration of a computer corresponding to the information processing apparatus according to the embodiment of the present disclosure, and is not necessarily limited to the configuration illustrated in FIG. 9.

As illustrated in FIG. 9, the computer 1000 includes a central processing unit (CPU) 1100, a random access memory (RAM) 1200, a read only memory (ROM) 1300, a hard disk drive (HDD) 1400, a communication interface 1500, and an input/output interface 1600. Each unit of the computer 1000 is connected by a bus 1050.

The CPU 1100 operates on the basis of a program stored in the ROM 1300 or the HDD 1400, and controls each unit. For example, the CPU 1100 develops a program stored in the ROM 1300 or the HDD 1400 in the RAM 1200, and executes processing corresponding to various programs.

The ROM 1300 stores a boot program such as a basic input output system (BIOS) executed by the CPU 1100 when the computer 1000 is activated, a program depending on hardware of the computer 1000, and the like.

The HDD 1400 is a computer-readable recording medium that non-transiently records a program executed by the CPU 1100, data used by the program, and the like. Specifically, the HDD 1400 records program data 1450. The program data 1450 is an example of the information processing program for implementing the information processing method according to the embodiment of the present disclosure and data used by the information processing program.

The communication interface 1500 is an interface for the computer 1000 to connect to an external network 1550 (for example, the Internet). For example, the CPU 1100 receives data from another equipment or transmits data generated by the CPU 1100 to another equipment via the communication interface 1500.

The input/output interface 1600 is an interface for connecting an input/output device 1650 and the computer 1000. For example, the CPU 1100 receives data from an input device such as a keyboard and a mouse via the input/output interface 1600. In addition, the CPU 1100 transmits data to an output device such as a display apparatus, a speaker, or a printer via the input/output interface 1600. Furthermore, the input/output interface 1600 may function as a media interface that reads a program or the like recorded in a predetermined recording medium (medium). The medium is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

For example, in a case where the computer 1000 causes the information processing apparatus according to the embodiment of the present disclosure to function as the imaging apparatus 10, the CPU 1100 of the computer 1000 executes the information processing program loaded on the RAM 1200 to implement various processing functions executed by each processing illustrated in FIG. 3. That is, the CPU 1100, the RAM 1200, and the like implement the information processing method by the information processing apparatus according to the embodiment of the present disclosure in cooperation with software (information processing program loaded on the RAM 1200).

### 7. Summary

Although the embodiment of the present disclosure have been described above, the technical scope of the present disclosure is not limited to the above-described embodiment as it is, and various changes can be made without departing from the gist of the present disclosure. In addition, the components of the embodiment and the modifications may be appropriately combined.

Furthermore, the effects of each embodiment described in the present specification are merely examples and are not limited, and other effects may be provided.

Note that the present disclosure can also have the following configurations.
(1) An information processing apparatus comprising:
   a determination unit that determines necessity of stopping tracking shooting currently being executed on a basis of whether or not a state of a subject on which the tracking shooting is being executed satisfies a predetermined condition; and
   a control unit that stops the tracking shooting of the subject according to a determination result of the necessity.
(2) The information processing apparatus according to the above (1), wherein
   in a case where it is determined that the tracking shooting needs to be stopped, the control unit stops the tracking shooting of the subject and performs control such that a current imaging range focused on the subject is switched to a wider imaging range not focused on the subject.
(3) The information processing apparatus according to the above (1), further comprising
   an image recognition unit that recognizes the state of the subject by analyzing a captured image of the subject obtained by the tracking shooting, wherein
   the determination unit determines that there is a need to stop the tracking shooting currently being executed in a case where the state of the subject indicated by a recognition result satisfies the predetermined condition.
(4) The information processing apparatus according to the above (3), wherein
   the image recognition unit detects a feature amount of a body of the subject from the captured image of the subject, and
   the determination unit determines that the tracking shooting needs to be stopped in a case where the subject and a tracking target are estimated to be different from each other by comparison between the feature amount of the body of the subject and a feature amount of a body detected from a captured image of a person registered in advance as the tracking target.
(5) The information processing apparatus according to the above (3), wherein
   the image recognition unit detects an orientation of a body of the subject from the captured image of the subject, and
   the determination unit determines that the tracking shooting needs to be stopped in a case where it is determined that the subject is continuously facing a predetermined direction for a certain period of time or more on a basis of a detection result in which the orientation of the body of the subject is detected.
(6) The information processing apparatus according to the above (3), wherein
   the image recognition unit detects a position of the subject on a basis of the captured image of the subject, and
   the determination unit determines that the tracking shooting needs to be stopped in a case where it is determined that the subject is not present at a position at which an original tracking target is estimated to be present on a basis of a detection result in which the position of the subject is detected.
(7) The information processing apparatus according to the above (3), wherein
   the image recognition unit detects an action of the subject on a basis of the captured image of the subject, and
   the determination unit determines that the tracking shooting needs to be stopped in a case where it is determined that the subject does not continuously exhibit a predetermined action for a certain period of time or more on a basis of a detection result in which the action of the subject is detected.
(8) The information processing apparatus according to the above (3), wherein
   the image recognition unit detects a motion amount of the subject on a basis of the captured image of the subject, and
   the determination unit determines that the tracking shooting needs to be stopped in a case where it is determined that the motion amount of the subject is out of a range of an action amount determined in advance according to a motion to be taken by the original tracking target.
(9) The information processing apparatus according to the above (3), wherein
   the image recognition unit detects a motion amount of the subject and a motion amount of another person on a basis of the captured image of the subject in a case where the another person not targeted for the tracking shooting is included in the captured image, and
   the determination unit determines that the tracking shooting needs to be stopped in a case where it is estimated that a motion to be taken by the original tracking target is not performed by the subject by comparison between the motion amount of the subject and the motion amount of the another person.
(10) The information processing apparatus according to the above (1), wherein
   the determination unit determines whether or not a state of each of a plurality of subject satisfies the predetermined condition in a case where the tracking shooting is performed such that the plurality of subjects falls within an angle of view, and determines the necessity of stopping the tracking shooting for the plurality of subjects on a basis of a relationship between determination results among the subjects.
(11) The information processing apparatus according to the above (10), wherein
   the determination unit determines that the tracking shooting needs to be stopped for the plurality of subjects in a case where any one of the plurality of subjects satisfies the predetermined condition.
(12) The information processing apparatus according to the above (11), wherein
   the determination unit determines that the tracking shooting needs to be stopped for the plurality of subjects in a case where all of the plurality of subjects satisfy the predetermined condition.
(13) The information processing apparatus according to the above (11), wherein
   the determination unit determines that it is not necessary to stop the tracking shooting targeting the plurality of subjects until remaining subjects also satisfy the predetermined condition in a case where any one of the plurality of subjects satisfies the predetermined condition.
(14) The information processing apparatus according to the above (1), wherein
   the information processing apparatus is communicably connected to an imaging apparatus having an imaging function,
   the determination unit determines the necessity of stopping the tracking shooting currently being executed on a basis of whether or not a state of a subject on which the tracking shooting is being executed by the imaging apparatus satisfies a predetermined condition, and
   in a case where it is determined that the tracking shooting needs to be stopped, the control unit stops the tracking shooting of the subject, and controls the imaging apparatus to switch from a current imaging range focused on the subject to a wider imaging range not focused on the subject for shooting.
(15) The information processing apparatus according to the above (1), wherein
   the information processing apparatus is communicably connected to an imaging apparatus that performs imaging of a type different from that of the information processing apparatus,
   the information processing apparatus further includes an acquisition unit that acquires state information indicating a state of the subject recognized by the imaging apparatus, the state being obtained as an analysis result for a captured image of the subject captured by the imaging apparatus,
   the determination unit determines the necessity of stopping the tracking shooting currently being executed on a basis of whether or not the state of the subject indicated by the state information satisfies a predetermined condition, and
   in a case where it is determined that the tracking shooting needs to be stopped, the control unit stops the tracking shooting of the subject and controls the own apparatus such that the current imaging range focused on the subject is switched to a wider imaging range not focused on the subject.
(16) The information processing apparatus according to the above
   the information processing apparatus is communicably connected to another imaging apparatus that performs imaging of a type different from that of the information processing apparatus,
   the information processing apparatus further includes an acquisition unit that acquires state information indicating a state of the subject recognized by an own apparatus and obtained as an analysis result for a captured image of the subject captured by the own apparatus,
   the determination unit determines the necessity of stopping the tracking shooting currently being executed on a basis of whether or not the state of the subject indicated by the state information satisfies a predetermined condition, and
   in a case where it is determined that the tracking shooting needs to be stopped, the control unit stops the tracking shooting of the subject, and controls the other imaging apparatuses to switch from a current imaging range focused on the subject to a wider imaging range not focused on the subject for shooting.
(17) An information processing method executed by an information processing apparatus, the information processing method comprising:
   a determination step of determining necessity of stopping tracking shooting currently being executed on a basis of whether or not a state of a subject on which the tracking shooting is being executed satisfies a predetermined condition; and
   a control step of stopping the tracking shooting of the subject according to a determination result of the necessity.
(18) An information processing program for causing an information processing apparatus to execute:
   a determination procedure of determining necessity of stopping tracking shooting currently being executed on a basis of whether or not a state of a subject on which the tracking shooting is being executed satisfies a predetermined condition; and
   a control procedure of stopping the tracking shooting of the subject according to a determination result of the necessity.

### REFERENCE SIGNS LIST

1 SYSTEM
10 IMAGING APPARATUS
12 IMAGE RECOGNITION UNIT
13 TRACKING DETERMINATION UNIT
14 ANGLE-OF-VIEW CONTROL UNIT
15 OUTPUT UNIT
16 STORAGE UNIT
20 USER APPARATUS
X EXTERNAL APPARATUS

1. An information processing apparatus comprising:
a determination unit that determines necessity of stopping tracking shooting currently being executed on a basis of whether or not a state of a subject on which the tracking shooting is being executed satisfies a predetermined condition; and
a control unit that stops the tracking shooting of the subject according to a determination result of the necessity.

2. The information processing apparatus according to claim 1, wherein
in a case where it is determined that the tracking shooting needs to be stopped, the control unit stops the tracking shooting of the subject and performs control such that a current imaging range focused on the subject is switched to a wider imaging range not focused on the subject.

3. The information processing apparatus according to claim 1, further comprising
an image recognition unit that recognizes the state of the subject by analyzing a captured image of the subject obtained by the tracking shooting, wherein
the determination unit determines that there is a need to stop the tracking shooting currently being executed in a case where the state of the subject indicated by a recognition result satisfies the predetermined condition.

4. The information processing apparatus according to claim 3, wherein
the image recognition unit detects a feature amount of a body of the subject from the captured image of the subject, and
the determination unit determines that the tracking shooting needs to be stopped in a case where the subject and a tracking target are estimated to be different from each other by comparison between the feature amount of the body of the subject and a feature amount of a body detected from a captured image of a person registered in advance as the tracking target.

5. The information processing apparatus according to claim 3, wherein
the image recognition unit detects an orientation of a body of the subject from the captured image of the subject, and
the determination unit determines that the tracking shooting needs to be stopped in a case where it is determined that the subject is continuously facing a predetermined direction for a certain period of time or more on a basis of a detection result in which the orientation of the body of the subject is detected.

6. The information processing apparatus according to claim 3, wherein
the image recognition unit detects a position of the subject on a basis of the captured image of the subject, and
the determination unit determines that the tracking shooting needs to be stopped in a case where it is determined that the subject is not present at a position at which an original tracking target is estimated to be present on a basis of a detection result in which the position of the subject is detected.

7. The information processing apparatus according to claim 3, wherein
the image recognition unit detects an action of the subject on a basis of the captured image of the subject, and
the determination unit determines that the tracking shooting needs to be stopped in a case where it is determined that the subject does not continuously exhibit a predetermined action for a certain period of time or more on a basis of a detection result in which the action of the subject is detected.

8. The information processing apparatus according to claim 3, wherein
the image recognition unit detects a motion amount of the subject on a basis of the captured image of the subject, and
the determination unit determines that the tracking shooting needs to be stopped in a case where it is determined that the motion amount of the subject is out of a range of an action amount determined in advance according to a motion to be taken by the original tracking target.

9. The information processing apparatus according to claim 3, wherein
the image recognition unit detects a motion amount of the subject and a motion amount of another person on a basis of the captured image of the subject in a case where the another person not targeted for the tracking shooting is included in the captured image, and
the determination unit determines that the tracking shooting needs to be stopped in a case where it is estimated that a motion to be taken by the original tracking target is not performed by the subject by comparison between the motion amount of the subject and the motion amount of the another person.

10. The information processing apparatus according to claim 1, wherein
the determination unit determines whether or not a state of each of a plurality of subject satisfies the predetermined condition in a case where the tracking shooting is performed such that the plurality of subjects falls within an angle of view, and determines the necessity of stopping the tracking shooting for the plurality of subjects on a basis of a relationship between determination results among the subjects.

11. The information processing apparatus according to claim 10, wherein
the determination unit determines that the tracking shooting needs to be stopped for the plurality of subjects in a case where any one of the plurality of subjects satisfies the predetermined condition.

12. The information processing apparatus according to claim 11, wherein
the determination unit determines that the tracking shooting needs to be stopped for the plurality of subjects in a case where all of the plurality of subjects satisfy the predetermined condition.

13. The information processing apparatus according to claim 11, wherein
the determination unit determines that it is not necessary to stop the tracking shooting targeting the plurality of subjects until remaining subjects also satisfy the predetermined condition in a case where any one of the plurality of subjects satisfies the predetermined condition.

14. The information processing apparatus according to claim 1, wherein
the information processing apparatus is communicably connected to an imaging apparatus having an imaging function,
the determination unit determines the necessity of stopping the tracking shooting currently being executed on a basis of whether or not a state of a subject on which the tracking shooting is being executed by the imaging apparatus satisfies a predetermined condition, and
in a case where it is determined that the tracking shooting needs to be stopped, the control unit stops the tracking shooting of the subject, and controls the imaging apparatus to switch from a current imaging range focused on the subject to a wider imaging range not focused on the subject for shooting.

15. The information processing apparatus according to claim 1, wherein
the information processing apparatus is communicably connected to an imaging apparatus that performs imaging of a type different from that of the information processing apparatus,
the information processing apparatus further includes an acquisition unit that acquires state information indicating a state of the subject recognized by the imaging apparatus, the state being obtained as an analysis result for a captured image of the subject captured by the imaging apparatus,
the determination unit determines the necessity of stopping the tracking shooting currently being executed on a basis of whether or not the state of the subject indicated by the state information satisfies a predetermined condition, and
in a case where it is determined that the tracking shooting needs to be stopped, the control unit stops the tracking shooting of the subject and controls the own apparatus such that the current imaging range focused on the subject is switched to a wider imaging range not focused on the subject.

16. The information processing apparatus according to claim 1, wherein
the information processing apparatus is communicably connected to another imaging apparatus that performs imaging of a type different from that of the information processing apparatus,
the information processing apparatus further includes an acquisition unit that acquires state information indicating a state of the subject recognized by an own apparatus and obtained as an analysis result for a captured image of the subject captured by the own apparatus,
the determination unit determines the necessity of stopping the tracking shooting currently being executed on a basis of whether or not the state of the subject indicated by the state information satisfies a predetermined condition, and
in a case where it is determined that the tracking shooting needs to be stopped, the control unit stops the tracking shooting of the subject, and controls the other imaging apparatuses to switch from a current imaging range focused on the subject to a wider imaging range not focused on the subject for shooting.

17. An information processing method executed by an information processing apparatus, the information processing method comprising:
a determination step of determining necessity of stopping tracking shooting currently being executed on a basis of whether or not a state of a subject on which the tracking shooting is being executed satisfies a predetermined condition; and
a control step of stopping the tracking shooting of the subject according to a determination result of the necessity.

18. An information processing program for causing an information processing apparatus to execute:
a determination procedure of determining necessity of stopping tracking shooting currently being executed on a basis of whether or not a state of a subject on which the tracking shooting is being executed satisfies a predetermined condition; and
a control procedure of stopping the tracking shooting of the subject according to a determination result of the necessity.
